(19) United States
(12) Patent Application Publication
(10) Pub. No.: US 2025/0381626 A1
(43) Pub. Date: Dec. 18, 2025

(54) PROCESSES OF REDUCING STRESS CORROSION CRACKING ON ALLOYS

(71) Applicant: CHEVRON U.S.A. INC., San Ramon, CA (US)

(72) Inventors: Talen S. Sehgal, San Ramon, CA (US); Orin Ryan Wakefield, San Ramon, CA (US); Christopher Robert Oliver, San Ramon, CA (US)

(21) Appl. No.: 18/742,304

(22) Filed: Jun. 13, 2024

(51) Int. Cl. B23K 31/02; B23K 103/08

(52) U.S. Cl. CPC B23K 31/02; B23K 2103/08

(57) ABSTRACT

The present application relates generally to reducing stress corrosion cracking on an alloy pipe or other component susceptible to stress corrosion cracking. The processes comprise inducing a compressive residual stress on an inner surface of the alloy pipe by flowing water or another media through the pipe. The outer surface of the alloy pipe is welded using multiple passes wherein one of the last passes of the welding is conducted while the compressive residual stress is induced. The inner surface to which the compressive residual stress is induced is generally opposite the outer surface of the pipe being welded.

### FIELD OF THE INVENTION

The present invention relates generally to welding processes that reduce stress corrosion cracking on alloys.

### BACKGROUND AND SUMMARY

Stress Corrosion Cracking occurs in a material when a tensile stress, a susceptible material, and a corrosive environment are present. This issue exists in metallic materials and is a very common failure mechanism. When this happens the failed component must be replaced which is costly in terms of loss of production or utilization in addition to the cost of the new component. In order to prevent this type of damage the alloy employed for the component may be upgraded. However, there may be some cases where there are limited or no material upgrades that are suitable for the application from, for example, a cost perspective. Thus, what is needed are specialized fabrication processes to prevent stress corrosion cracking. It would be beneficial if such processes could be applied on commercial alloys that do not have cost effective upgrades available such as, for example, nickel-based alloys. It would further be beneficial if the processes were not time-intensive, were not labor intensive, and significantly reduced or eliminated stress corrosion cracking.

Advantageously, the embodiments described herein accomplish one or more up to all of the aforementioned needs.

In one embodiment, the application pertains to a process for reducing stress corrosion cracking on an alloy component susceptible to stress corrosion cracking. The process comprises inducing a compressive residual stress on at least a portion of a first surface, e.g., root side, of the alloy component at a location where the component is susceptible to stress corrosion cracking. A second surface of the alloy component is welded, e.g., face side. The welding comprises conducting at least one welding pass while the compressive residual stress is induced. At least a part up to all of the portion of the first surface to which the compressive residual stress is induced is opposite the second surface of the alloy component being welded during the at least one welding pass. The alloy of the alloy component has a mean coefficient of thermal expansion of less than about 18.5×10⁻⁶ m/m-K at 24-927° C.

In another embodiment, the application pertains to a process for reducing stress corrosion cracking on a pipe susceptible to stress corrosion cracking. The process comprises inducing a compressive residual stress on an inner surface of the alloy pipe by flowing a heat sinking media through the pipe. An outer surface of the alloy pipe is welded using multiple passes. One of the last passes or the last pass of the welding is conducted while the compressive residual stress is induced. The inner surface to which the compressive residual stress is induced is opposite the outer surface of the pipe being welded. The alloy of the pipe may comprise C-276, other nickel-based alloys, and similar alloys such as those with similar mean thermal expansion coefficients.

### BRIEF DESCRIPTION OF THE DRAWINGS

So that the manner in which the above recited features, advantages, and objects of the present invention are attained and can be understood in detail, a more particular description of the invention, briefly summarized above, may be had by reference to the embodiments thereof which are illustrated in the appended drawings. It is to be noted, however, that the appended drawings only illustrate preferred embodiments of this invention and are therefore not to be considered limiting of its scope, for the invention may admit to other equally effective embodiments that vary only in detail.

FIG. 1 shows aluminum-chloride based ionic liquid corrosion rates in common metallurgies at hydro-regen (HRR) conditions: 350-400° F. IL with H₂ and 10,000 ppm HCl.

FIG. 2 shows metal distortion after welding.

FIG. 3 shows a temperature heating curve of an alloy component during the WACS process.

FIG. 4 shows predicted residual stress states during and after the WACS process.

FIG. 5 shows average residual middle principal stress by water temperature and flow rate.

FIG. 6 shows middle principal stress 10 minutes after welding (air cooled) at 10× magnification.

FIG. 7 shows middle principal stress 10 minutes after welding (15 GPM of water cooling).

FIG. 8 shows welding setup for empirical WACS testing.

FIG. 9 shows measured residual stress measurement data in the hoop direction (0°) at various axial distances from the toe of the weld.

FIG. 10 shows measured residual stress measurement data in the axial direction (90°) at various axial distances from the toe of the weld.

### DETAILED DESCRIPTION

Certain terms are used throughout the following description and claims to refer to particular system components. As one skilled in the art will appreciate, different companies may refer to a component by different names.

### Definitions

The terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s) but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of +10 percent of the given numeric value provided such a deviation does not alter the end function or result of the value. Therefore, a value of about 1% can be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

The term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

This written description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have elements that do not differ from the literal language of the claims, or if they include equivalent elements with insubstantial differences from the literal language of the claims.

Unless defined otherwise, all technical and scientific terms used herein have the same meanings as commonly understood by one of skill in the art to which the disclosed invention belongs. All citations referred herein are expressly incorporated by reference.

### General Process

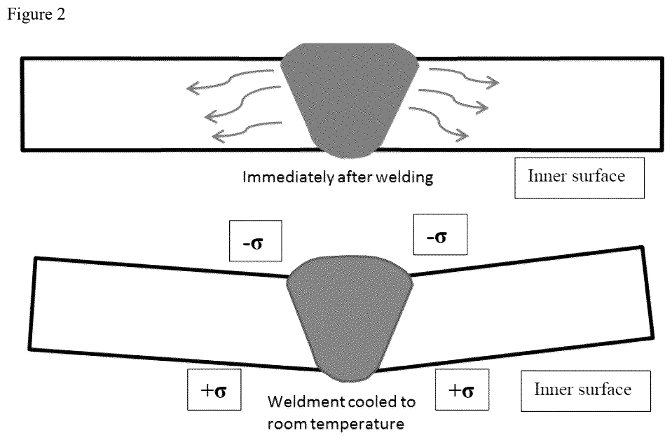

In one embodiment the application pertains to Welding Activated Compression State (WACS) processes. The WACS processes used herein generally seek to turn a residual tensile stress (+σ) into a residual compressive stress (−σ) on a surface of a material, preferably the inner surface of a material, e.g., the surface opposite of the surface on which a final or near final weld pass is made and which may be exposed to an environment susceptible to stress corrosion cracking. When a material is welded traditionally, there is some thermal expansion on the outer surface, and the material attempts to bend outwards towards the heated surface. As the weldment cools and contracts, a bending moment imparts a tensile stress (+σ) on the inner surface of the material, being constrained by the plastic strain of the inner surface, as shown in FIG. 2.

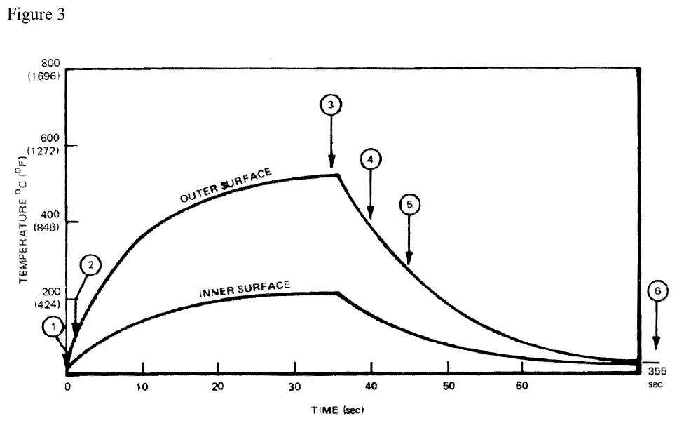

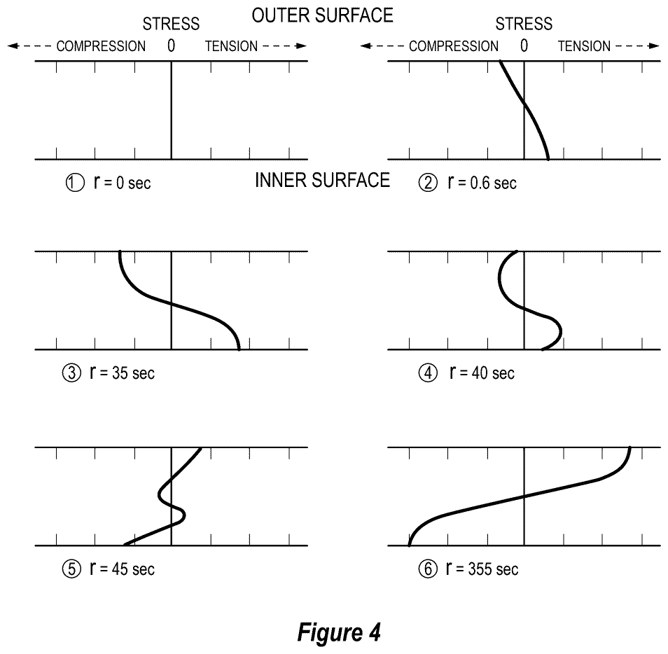

Since the material is traditionally cooled in air at ambient conditions, there is no additional driving force for any changes in this stress state, and it thus gets ‘locked-in’. However, it has been discovered that by rapidly cooling the inner surface of the material as heat is applied externally, a large thermal gradient occurs between the inner and outer surfaces. The heating initially yields the outer surface of the piping in compression and the cooler inside surface initially yields in tension. While cooling, the outer surface contracts slower than the inner surface, flipping the stress state of the inner surface to compression and the outer surface to tension. A model of the stress state over time is shown in FIGS. 3 and 4.

Processes for reducing stress corrosion on an alloy component susceptible to stress corrosion are described herein. The processes generally comprise employing a compressive residual stress on at least a portion of a first surface, e.g., root side, of the alloy component at a location where the component is susceptible to stress corrosion cracking. A second surface, e.g., face side, of the alloy component is welded usually conventional welding techniques except that at least one welding pass is conducted while the compressive residual stress is induced to the opposing side. That is, at least a part up to all of the portion of the first surface to which the compressive residual stress is employed is opposite the second surface of the alloy component being welded.

### Alloy Component

The alloys of the alloy component are not particularly limited and may vary depending upon the component, the corrosion conditions, and desired corrosion resistance. In some embodiments it has surprisingly been discovered that the alloy of the alloy component may have a relatively low mean coefficient of thermal expansion such as a mean coefficient of thermal expansion of less than about 18.5×10⁻⁶m/m-K at 24-927° C., or less than about 18.2×10⁻⁶m/m-K at 24-927° C., or less than about 18×10⁻⁶m/m-K at 24-927° C., or less than about 17.5×10⁻⁶m/m-K at 24-927° C., or less than about 17×10⁻⁶m/m-K at 24-927° C. In some embodiments, suitable alloys of the alloy component may comprises a P number 1 base metal or a P number 43 base metal according to ASME Section IX. In particular, the alloy of the alloy component may comprise a nickel-based alloy. Such nickel-based alloys may if desired, further comprise chromium, molybdenum, or any mixture thereof. A particularly suitable alloy may be C-276 such as those available as HASTELLOYRC-276 or INCONEL®C-276. In some embodiments, the alloy of the alloy component may comprise a carbon steel.

The type of alloy component is not particularly limited so long as a compressive residual stress may be induced on at least a portion of a first surface, e.g., root side, of the alloy component at a location where the component is susceptible to stress corrosion cracking while a welding pass is undertaken on the opposing side, e.g., face side. Such alloy components include, for example, pipes and vessels of various shapes and sizes that are used in corrosive environments such as oil and gas or petrochemical applications.

### Welding

Conventional or unconventional welding techniques may be employed so long as the compressive residual stress is induced during one or more welding passes as described herein. Suitable welding techniques and variables are described in, for example, ASME Section IX which is incorporated herein by reference. As one of ordinary skill in the art appreciates a pass is a single progression of welding along a joint with the result of the pass being a weld bead. The number of passes may depend upon a number of factors such as, for example, the type of joint, the materials, the component being welded, and the desired results. The type of weld joint is not particularly limited and are often one sided weld joints. Such one sided welds are found in, for example, pipes and vessels and may include, for example, a square butt weld, a vee weld, and the like. In some embodiments, the compressive residual stress that is induced during one or more welding passes is conducted during one of the later passes, e.g., one or more of the last three passes, the last two passes, or the last pass.

The compressive residual stress may be induced in any convenient manner and may vary depending on such factors as the shape and configuration of the alloy component, as well as the desired amount of compressive residual stress to be induced and/or will exist upon completion of a weld application or process. For example, the compressive residual stress may be induced using a cooling media, a heating media, and/or a combination thereof. The heating or cooling media may be a heat transfer fluid such as, for example, an oil, a glycol, an alcohol, water, or any combination thereof.

The heating or cooling media is usually employed on or applied to the opposing side that is being welded. For example, if the alloy component is a pipe, then water or another fluid may be flowed through the interior of the pipe at one or more locations where the pipe is susceptible to stress corrosion cracking. While the water or another fluid is flowing one or more welding passes are conducted on the exterior of the pipe at the one or more locations susceptible to stress corrosion cracking. In this manner, the effects shown in FIG. 2 may be achieved to increase resistance to stress corrosion cracking. In some embodiments, heating such as inductive heating may be employed to induce compressive residual stress. Inductive heating may be particularly useful on carbon steel components. In some embodiments the water or other fluid may not necessarily be flowing, but rather, simply applied at the appropriate location to induce a desired amount of stress.

The filler employed in the welding may be any filler that is compatible with the specific alloy of the alloy component and provides the desired increase in resistance to stress corrosion cracking. In some embodiments the filler comprises an F43 or F44 filler according to ASME Section IX. In some embodiments the filler may comprise an F1, F2, F3, F4, or F6 (excluding A8) filler. Particularly suitable fillers may comprise a filler that meets ASME-SFA-5.14 specifications.

Advantageously, by welding using the inducement of compressive residual stress in a pass as described herein, an immunity to stress corrosion cracking may be imparted on the metal compared to the same welding process without application of the aforementioned techniques.

### Examples

### Alloy C-276 Base Material and Alloy 686 Weld Material

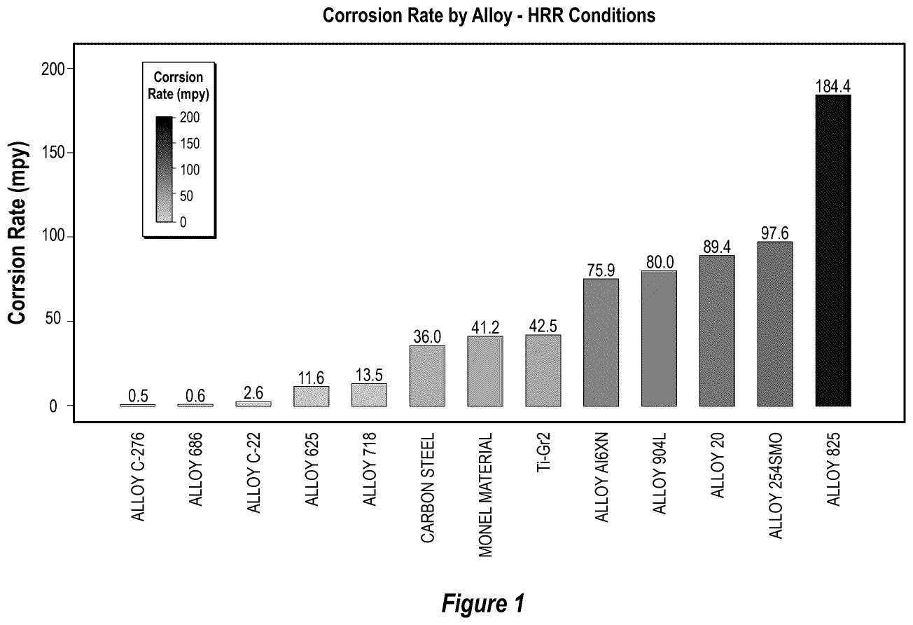

The examples described here employ the WACS processes described above with an Alloy C-276 Base Material and Alloy 686 Weld Material in an application wherein aluminum-chloride based ionic liquid was contributing to stress corrosion cracking in a hydro-regen process for alkylation. Thus, FIG. 1 shows Aluminum-chloride based ionic liquid corrosion rates in common metallurgies at general hydro-regen (HRR) conditions: 350-400° F. ionic liquid with H₂ and 10,000 ppm HCl. However, as described above many other suitable materials may be employed as a base material or weld material depending upon the application.

The WACS processes used herein generally seek to turn a residual tensile stress (+σ) into a residual compressive stress (−σ) on the inner surface of a material. When a material is welded traditionally, there is some thermal expansion, and the material attempts to bend outwards. As the weldment cools and contracts, a bending moment imparts a tensile stress (+6) on the inner surface of the material, as shown in FIG. 2.

### Modeling of Welds

Two finite element models were created to investigate stress state sensitivity to various welding parameters and water flow conditions. The models consisted of a 2-D axisymmetric section of an NPS 4 Schedule 40 pipe with a typical single vee butt weld geometry. The models used an Alloy C-276 base material with a 1/16^{th} and ⅛^{th} inch tall ERNiCrMo-14 weld cap. Mechanical properties for the modeled materials were taken from ASME Section II, Part D up to their tabulated limits (generally 650° C. to 815° C.) and then extrapolated up to the melting points listed in WRC 503. Transient weld deposition was simulated by first raising the weld cap temperature from ambient to molten (1310° C.) in one second and followed by one second of sustained molten temperature of the weld cap. Cooling was then simulated over 10 minutes by application of convective heat film coefficients along the pipe OD (using still air) and ID (using various cooling media flow rates). After simulating heat flow through the weld cap into the base material, the transient temperature distributions were imported to the structural model where thermal displacements and residual stresses were calculated and extracted from the models. The models show a decrease in residual stresses on the inner surface of the piping when compared to traditional welding with no internal cooling effect. In the case of an ID surface-breaking circumferentially oriented crack, the main stress state of interest is the middle principal stress. Axially oriented normal stresses and, to a lesser extent, radially oriented shear stresses, would tend to drive such a crack to open. Both stress components are considered in the middle principal stress calculation.

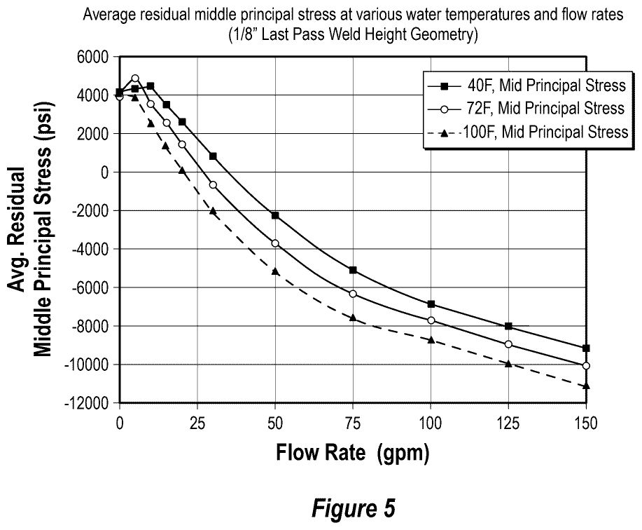

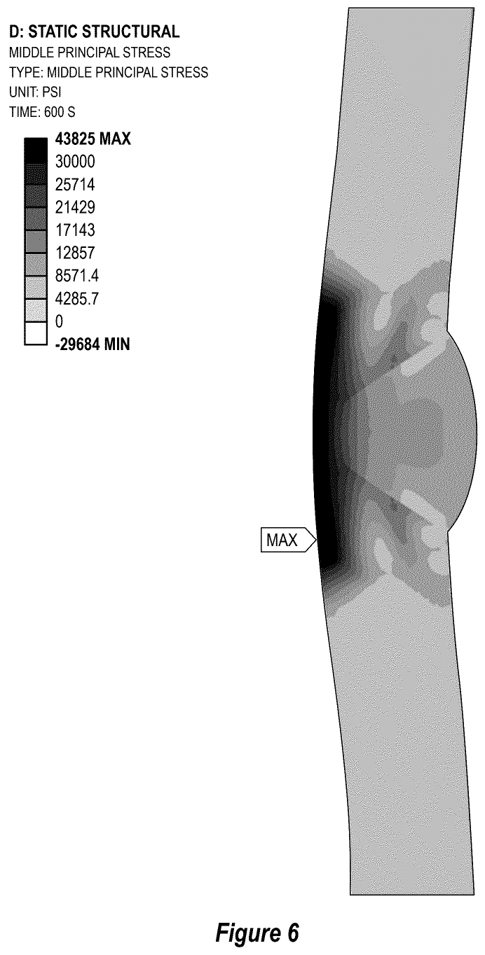

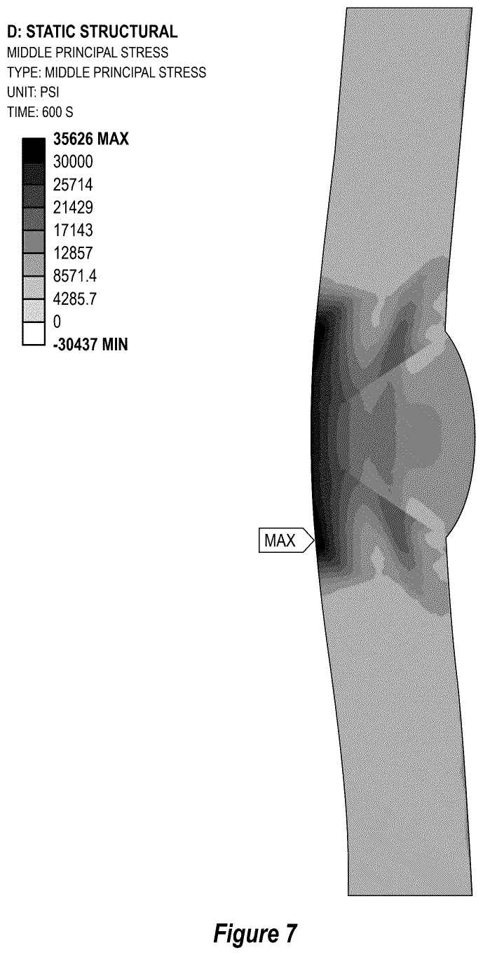

FIG. 5 shows an overall trend of residual stresses from the model results. Due to the changes in thermal conductivity of the cooling media, there is a slight difference in the cooling effects of water at the same flow rates. Warmer water provides a greater overall cooling effect due to higher thermal conductivity and therefore tends to create a stronger compressive (i.e., more negative) residual stress. Between 20-30 gallons per minute of flow (temperature dependent), the average residual stress components of these curves dip into the compressive range. As flow rate increases, there is more compressive stress on the components. While a compressive stress field may minimize or even negate a driving force for crack initiation and propagation, a decrease in tensile residual stresses is a directional improvement towards crack prevention. FIGS. 6 and 7 show this decrease in residual stresses between air cooling and 15 gallons per minute (GPM) of water flow. Specifically, FIG. 6 shows middle principal stress 10 minutes after welding (air cooled) at 10× deflection scale. FIG. 7 shows middle principal stress 10 minutes after welding (15 GPM of water cooling) at 10× deflection scale.

### Empirical Testing of Welds

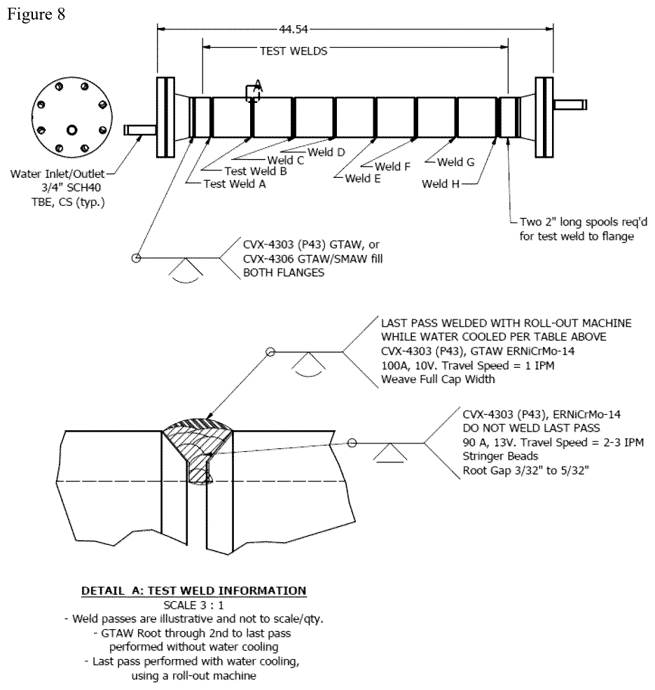

Alloy C-276 piping was cut and welded using the WACS techniques. Eight sections were cut out of an NPS 4 Schedule 40 spool and were subsequently prepped and welded back together for the root and fill passes. The last pass was done using a pipe-roller setup with water flowing at various rates. The testing matrix and setup is described in FIG. 8 and Table 1 below, along with the measured flow rates during testing.

TABLE 1
Welding test matrix

| Test Weld | Measured Water Flow Rate (GPM) |
|---|---|
| A | No water |
| B | 0 (liquid packed) |
| C | 4.7 |
| D | 9.9 |
| E | 16 |
| F | 12 |
| G | No water |
| H | No water |

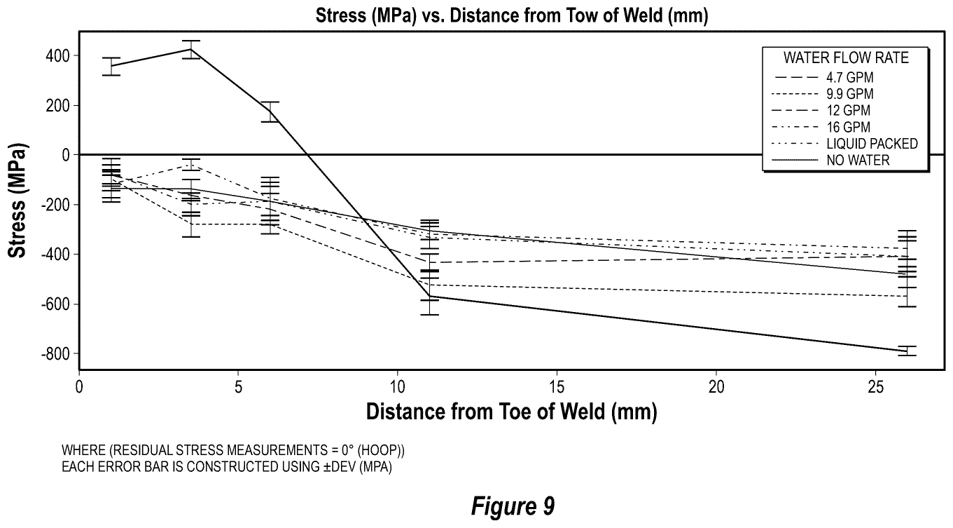

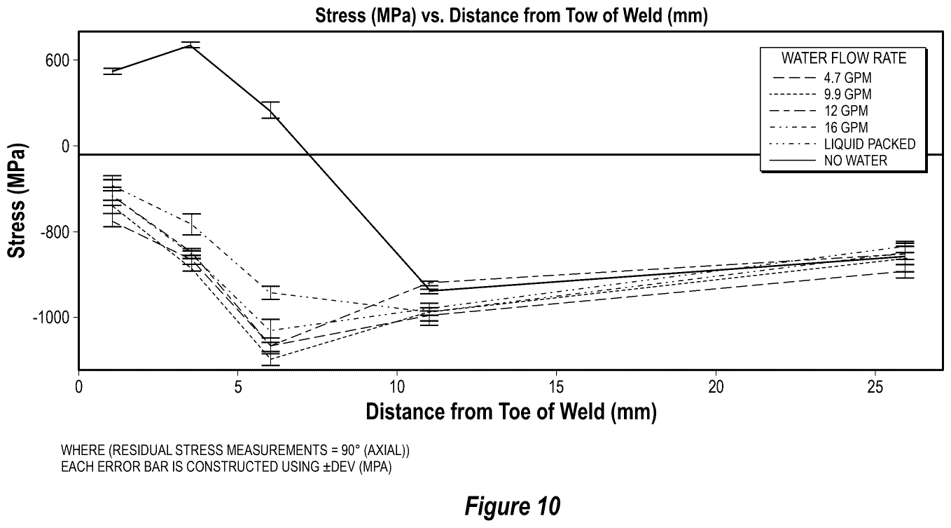

Upon completion of the welding, test specimens were cut out and measured for residual stress along the inner surface of the pipe segments. Testing was done in compliance with EN 15305, ASTM E915-16, and SAE HS-784 techniques. Measurements were taken at several distances away from the toe of the weld between 1 and 26 mm in both the axial and circumferential directions. For circumferential cracking, the axial direction residual stresses are often a driving factor, while cracking along the length of the pipe is usually driven by circumferential residual stresses. Graphs showing the measured residual stresses at the flow rates detailed in Table 1 are shown in FIGS. 9 and 10.

Testing showed even better results than the modeling described above. The inner surface measurements shown in FIGS. 9 and 10 indicate significant compressive stresses on the inner surface of the material at all flow rates tested, including in the water packed but no flow condition. In the no water control condition, a tensile residual stress was measured in both the hoop and axial directions. This is expected, as a tensile stress is created after “traditional” welding, as shown in FIG. 2 above. At the edge of the far heat affected zone, the material transitions between a tensile stress and a compressive stress at σ=0. This then translates into the base material, where the lines converge. In the IL-SCC case, this lines up with the observations and failure analyses from piping in the field as no base metal cracking was found away from stressed areas.

It will be understood that various modifications may be made to the embodiments disclosed herein. Therefore, the above description should not be construed as limiting, but merely as exemplifications of example embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A process for reducing stress corrosion cracking potential on an alloy component susceptible to stress corrosion cracking wherein the process comprises:
inducing a compressive residual stress on at least a portion of a first surface of the alloy component at a location where the component is susceptible to stress corrosion; and
welding a second surface of the alloy component, wherein the welding comprises conducting at least one welding pass while the compressive residual stress is induced;
wherein at least a part up to all of the portion of the first surface to which the compressive residual stress is induced is opposite the second surface of the alloy component being welded; and
wherein the alloy of the alloy component has a mean coefficient of thermal expansion of less than about 18.5×10⁻⁶ m/m-K at 24-927° C.

2. The process of claim 1 wherein the alloy of the alloy component comprises a P number 1 base metal or a P number 43 base metal according to ASME Section IX.

3. The process of claim 1 wherein the alloy of the alloy component comprises a nickel-based alloy.

4. The process of claim 3 wherein the alloy further comprises chromium.

5. The process of claim 4 wherein the alloy further comprises molybdenum.

6. The process of claim 2 wherein the alloy is C-276.

7. The process of claim 1 wherein the alloy of the alloy component comprises a carbon steel.

8. The process of claim 1 wherein the welding comprises employing a filler compatible with the alloy of the alloy component.

9. The process of claim 1 wherein the filler comprises an F43 filler according to ASME Section IX.

10. The process of claim 1 wherein the filler comprises a filler that meets ASME-SFA-5.14 specification.

12. The process of claim 1 wherein the alloy component is a pipe.

13. The process of claim 1 wherein the alloy component is a pressure vessel.

14. The process of claim 1 wherein inducing the compressive residual stress comprises the use of a cooling media.

15. The process of claim 14 wherein the cooling media is a heat transfer fluid.

16. The process of claim 14 wherein the heat transfer fluid comprises an oil, a glycol, an alcohol, water, or any combination thereof.

17. The process of claim 16 wherein the heat transfer fluid comprises water.

18. The process of claim 1 wherein inducing the compressive residual stress comprises the use of inductive heating.

19. The process of claim 1 wherein the welding comprises employing multiple welding passes and wherein the conducting of at least one welding pass while the compressive residual stress is induced is employed on the last pass of the multiple welding passes.

20. A process for reducing stress corrosion cracking on an alloy pipe susceptible to stress corrosion wherein the process comprises:
inducing compressive residual stress on an inner surface of the alloy pipe by flowing water through the pipe; and
welding an outer surface of the alloy pipe using multiple passes wherein the last pass of the welding is conducted while the compressive residual stress is induced;
wherein the inner surface to which the compressive residual stress is induced is opposite the outer surface of the pipe being welded; wherein the alloy of the pipe comprises C-276.
